(19) United States
(12) Patent Application Publication
(10) Pub. No.: US 2011/0107258 A1
(43) Pub. Date: May 5, 2011

(54) Icon/text interface control method

(76) Inventor: Tonny Chen, Shengang Shiang (TW)

(21) Appl. No.: 12/588,980

(22) Filed: Nov. 4, 2009

(51) Int. Cl. G06F 3/048

(52) U.S. Cl. 715/810

(57) ABSTRACT

An icon/text interface control method and particularly a control method incorporating with an icon/text menu interface displayed on a screen of a display device to facilitate user operation through selection. The method includes the procedures of: opening an option page, detecting contact of a user's finger on a touch panel and calculating coordinates of the finger center, mapping the position of the finger center to the screen, generating icon alteration of a corresponding option; executing a measure to prevent depressing deviation, and executing the selected option. Through a corresponding icon/text menu displayed on the screen options can be selected as desired to enable users to see and execute the selected options easily and quickly.

### BACKGROUND OF THE INVENTION

1. Field of the Invention

The present invention relates to an icon/text interface control method and particularly to a control method incorporating with an icon/text menu interface displayed on a screen of a display device to facilitate user operation by seeing and selecting options.

2. Description of the Prior Art

Most conventional electronic products nowadays provide remote control function to facilitate user operation. Hence performing remote operation through a remote controller becomes a mandatory function of many electronic products. As the functions of electric devices become more complicated and versatile, such as DVD, MP3 music players, vehicle navigation, digital TV and the like, multiple functions are increasingly popular. Thus the number of buttons on the remote controller also increases. Some of them are composite keys. Namely one button provides different functions in different conditions. This makes operation of the remote controller more complicated. Users have to spend a lot of time to learn operations. And most users can use only a small portion of functions that are simpler.

The viewing window interface on computers also provides complicated functions, but is much easier to learn for users. This is because the computer viewing window interface has an icon/text interface. Through a mouse cursor icon functional items on the screen can be selected. In some occasions when the cursor is moved to an icon option a text description appears to enable users to familiarize the operation even easier without much trials and errors. Moreover, as the computer is very popular these days, most people are familiar with operation of the computer icon interface. To make operation of electric devices like computer operation will greatly boost user friendliness.

In short, the control method of the conventional electronic products has evolved from the button remote control approach in the past to a remote controller L equipped with a touch screen (referring to FIG. 1). For instance Taiwan patent No. I248261 (called reference 1 hereinafter) discloses a control method which has a plurality of composite function keys L1 on a touch screen L0 to provide command operation of different functions. The picture of the touch screen L0 is changeable according to different functions. The same touch zones in different pictures often provide different operational functions. Operation is complicated. Moreover, due to constraint, of the touch screen L0, the size of displaying text is smaller. It creates a great burden to user's eye sight. Another reference is Taiwan patent publication No. M281228 which discloses a design with a touch screen on a′ mouse. By touching the touch screen on the mouse operation commands can be entered. But it also has the drawbacks of reference 1.

### SUMMARY OF THE INVENTION

Therefore it is an object of the present invention to provide an icon/text interface control method incorporating with an icon/text menu interface displayed on a screen of a display device to facilitate user operation through selection. The method includes the procedures as follow:

open an option page;

detect contact of a user's finger on a touch panel and calculate coordinates of the finger center;

map the position of the finger center to the screen;

generate icon alteration of a corresponding option;

execute a measure to prevent depressing deviation; and

execute the selected option.

By means of the procedures set forth above, users can easily see and quickly perform operation of the selected option from a corresponding icon/text menu displayed on the screen of a display device.

In one aspect of the invention the coordinates of the touch panel adopt Descartes coordinate system.

In another aspect the coordinates of the touch panel adopt absolute coordinates, and the position on the touch panel touched by the finger serves as the basis of the cursor appearing on the screen of the display device.

In yet another aspect the step of open an option page is revoked after the step of detect contact of a user's finger on a touch panel and calculate coordinates of the finger center does not exist and absence of the finger from the touch panel for a set time period is detected, and a preceding page is resumed.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional remote controller.

FIG. 2 is a schematic view of the remote controller of the invention.

FIG. 3 is schematic view-1 of an embodiment of the invention.

FIG. 4 is a flowchart of the method of the invention.

FIG. 5 is schematic view-2 of an embodiment of the invention.

FIG. 6 is a flowchart of a first embodiment of the step of generate icon alterations of a corresponding option.

FIG. 7 is schematic view-3 of an embodiment of the invention.

FIG. 8 is schematic view-4 of an embodiment of the invention.

FIG. 9 is a flowchart of a second embodiment of the step of generate icon alterations of a corresponding option.

FIG. 10 is a flowchart of a third embodiment of the step of generate icon alterations of a corresponding option.

FIG. 11 is a flowchart of a fourth embodiment of the step of generate icon alterations of a corresponding option.

FIG. 12 is a flowchart of a first embodiment of the step of execute a measure to prevent depressing deviation;

FIG. 13 is a schematic view of the first embodiment of the step of execute a measure to prevent depressing deviation;

FIG. 14 is a flowchart of a second embodiment of the step of execute a measure to prevent depressing deviation;

FIG. 15 is a schematic view of the second embodiment of the step of execute a measure to prevent depressing deviation;

FIG. 16 is a schematic view of the second embodiment of the step of execute a measure to prevent depressing deviation showing the relationship between memory space and time.

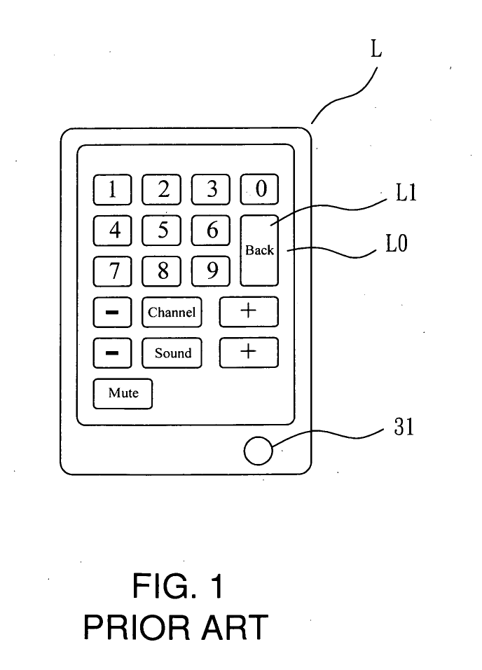

### DESCRIPTION OF THE PREFERRED EMBODIMENTS

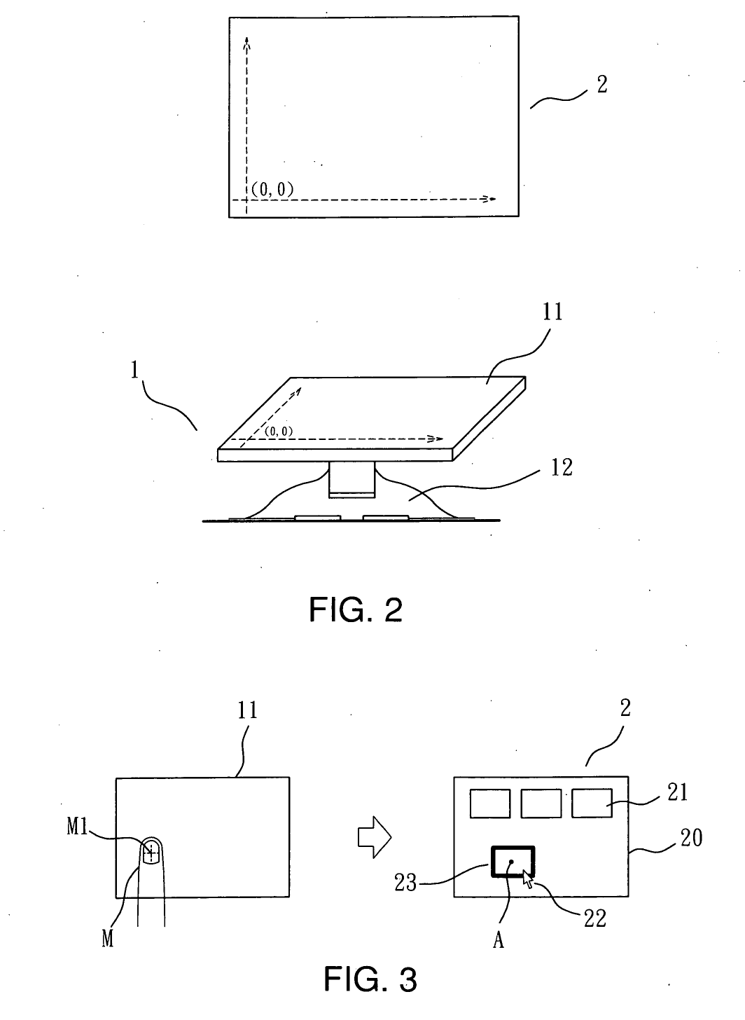

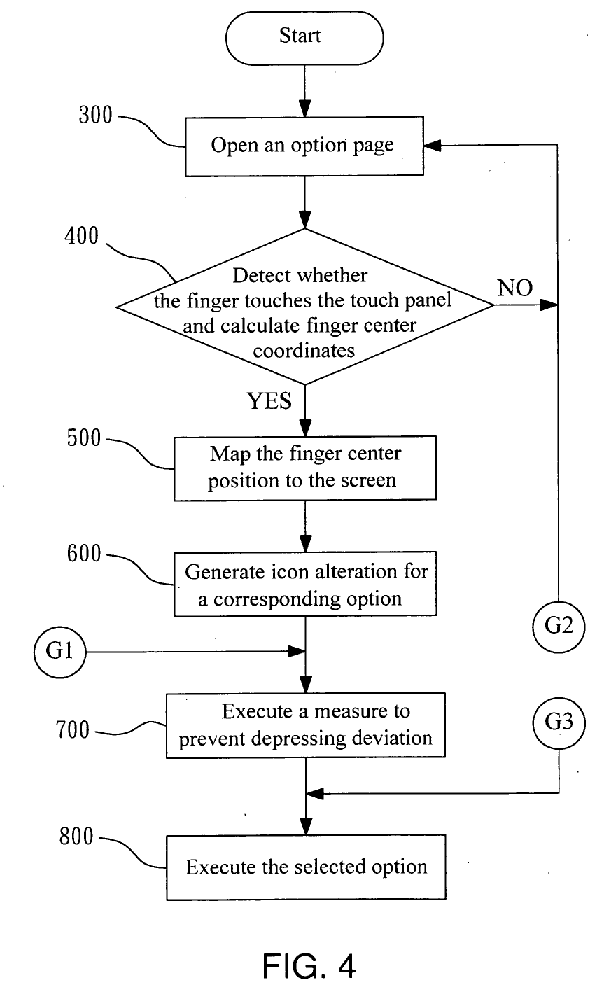

Refer to FIG. 2 for an embodiment of the remote controller according to the invention. The remote controller 1 includes at least one button switch 12 incorporating with a display device 2. The button switch 12 aims to execute depressed input function and has a touch panel 11 located thereon to detect finger touch and position thereof. The touch panel 11 is controlled by a system and maps a coordinate displayed on a screen 20 of the display device 2 in an one-to-one fashion (referring to FIG. 3). The touch panel 11 further is divided into at least one zone corresponding to options 21 on the screen 20. By means of the construction set forth above the control method of the invention can be implemented. The control method includes at least the procedures as follow (referring to FIG. 4):

open an option page (step 300): the screen 20 of the display device 2 displays a picture of a plurality of options 21. The coordinates of the touch panel 11 and the screen 20 are calculated based on Descartes coordinate system. The touch panel 11 maps the coordinates displayed on the screen 20 in an one-to-one fashion (such as by absolute coordinates);

detect contact of a user's finger on the touch panel and calculating coordinates of the finger center (step 400): when a finger M touches the touch panel 11, the touch panel 11 detects the touch signal of the finger M and calculates the coordinates of the finger center M1, and executes step 500; otherwise, if there is no detection of the finger M, goes to step 300;

map the position of the finger center to the screen (step 500): the coordinates of the touch panel 11 map the coordinates of the screen 20, and the position of the finger center M1 maps a corresponding position A on the screen 20, and a cursor 22 is generated corresponding to the position A;

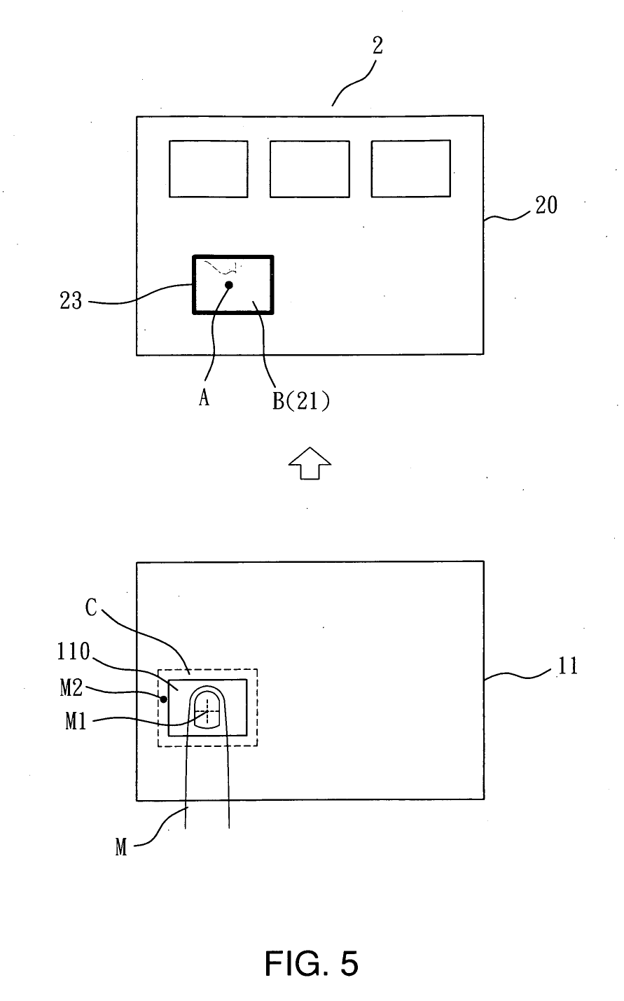

generate icon alteration of a corresponding option (step 600): when the position A on the screen 20 corresponding to the finger center M1 is located in a set covering scope B of a set option 21 (referring to FIG. 5), an icon alteration is generated on the option 21 (inverse color or surrounded by a frame 23);

execute a measure to prevent depressing deviation (step 700): when the finger M touches the touch panel 11, if the position A on the screen 20 corresponding to the finger center M1 (referring to FIG. 5) is located in the set covering scope B of the option 21, a depressing effective zone 110 of the touch panel 11 is expanded temporarily to a bordering zone C to compensate deviation of a depressing spot M2 occurred during depressing operation; and

execute the selected option (step 800): the function of the selected option 21 is output.

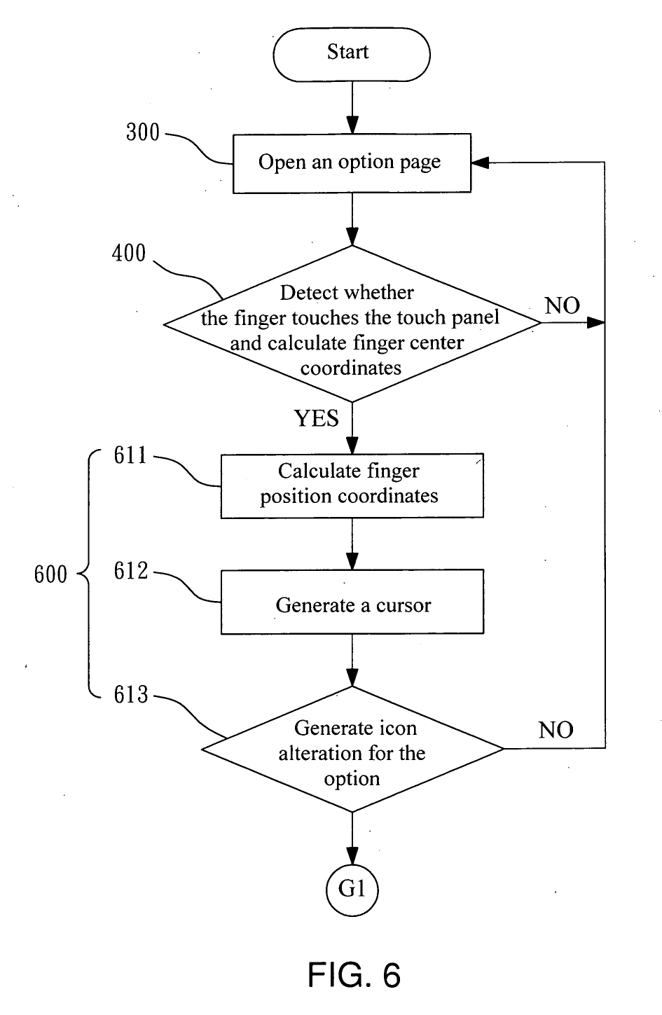

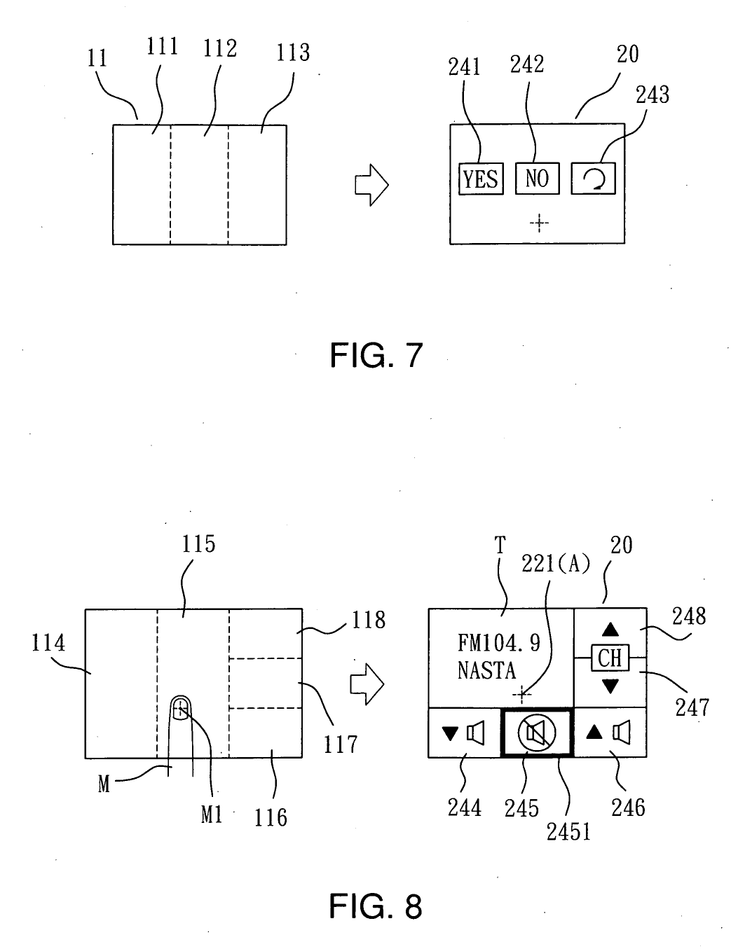

The step 600 of generate icon alteration of a corresponding option includes embodiments as follow. Referring to FIG. 6 for a first embodiment of step 600 (also referring to FIG. 3). This step further includes the following procedures:

a. calculate the coordinates of the finger position (step 611): get the coordinate position of the finger center M1 on the touch panel 11;

b. generate a cursor (step 612): display a cursor 22 at the corresponding position A on the screen 20 according the touch coordinate position of the mapping finger center M1 to allow users to understand the position touched by the finger M. The cursor 22 is a highlighted symbol (such as an arrow or cross symbol); and

c. generate icon alteration for the option (step 613): when the finger center M1 moves on the touch panel 11, the cursor 22 on the screen 20 also is driven and moved accordingly. If the cursor 22 is overlapped with the option 21 on the screen 20, an icon alteration is generated for the option 21 (such as inverse color or surrounded by a frame 23), and step 700 is executed; otherwise execute step 300.

By means of the procedures set forth above users can select required options by moving the cursor 22 to make selection more convenient.

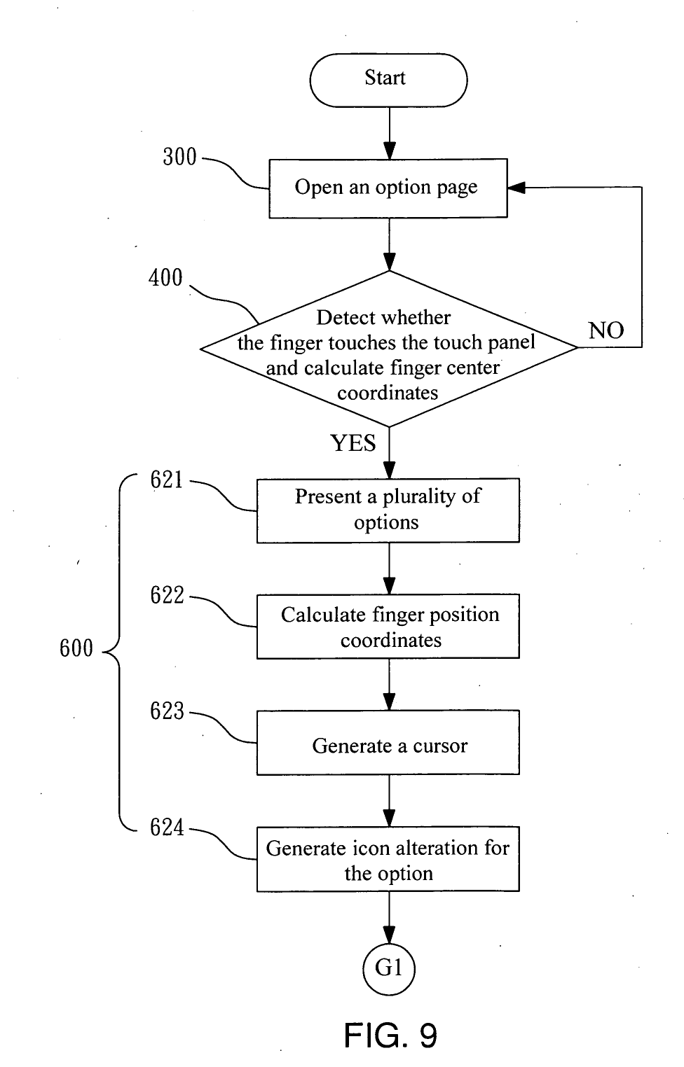

Refer to FIGS. 7, 8 and 9 for a second embodiment of step 600. It aims to make selection of the option easier. On the screen 20 an open page is opened (step 300) with segments of options 241, 242 and 243 located thereon. The touch panel 11 also is divided into one or more zones 111, 112 and 113 corresponding to the segments mentioned above. By depressing any of the zones 111, 112 and 113 the representing segment 241, 242 or 243 is input without the need of moving the cursor 221. Referring to FIG. 8, the screen 20, aside from displaying options 244, 245, 246, 247 and 248, also shows character T. Then the touch panel 11 also is divided into corresponding zones of 114, 115, 116, 117 and 118. The step 600 further includes the following procedures:

a. present a plurality of options (step 621): the screen 20 displays a plurality of options 244, 245, 246, 247 and 248 (referring to FIG. 8), and the touch panel 11 is divided into more than one zone 114, 115, 116, 117 and 118 corresponding to the options 244, 245, 246, 247 and 248;

b. calculate the coordinate of finger position (step 622): get the coordinate position of the finger center M1 on the touch panel 11;

c. generate a cursor (step 623): display a cursor 221 at the corresponding position A on the screen 20 according to the touch coordinate position of the mapping finger center M1 to allow users to understand the position touched by the finger M. The cursor 221 is a highlighted symbol (such as an arrow or cross symbol); and

d. generate icon alteration for the options (step 624): the zones 114, 115, 116, 117 and 118 where the finger center M1 is located are corresponding to the options 244, 245, 246, 247 and 248 displayed on the screen 20, then generate icon alterations on the options 244, 245, 246, 247 and 248 (such as inverse color or surrounded by a frame 2451), and execute step 700.

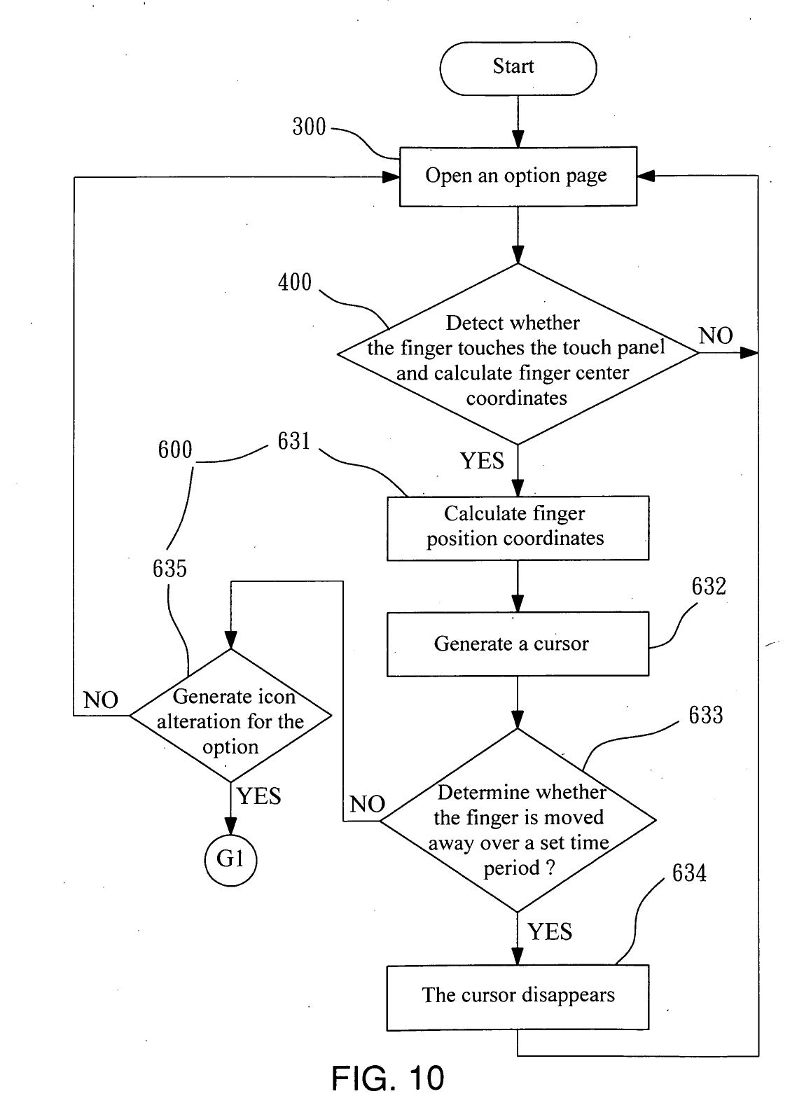

Refer to FIG. 10 (also FIG. 8) for a third embodiment of step 600 for generating icon alteration of a corresponding option. It includes procedures as follow:

a. calculate the coordinate of finger position (step 631): get the coordinate position of the finger center M1 on the touch panel 11;

b. generate a cursor (step 632): display a cursor 221 at the corresponding position A on the screen 20 according the touch coordinate position of the mapping finger center M1 to allow users to understand the position touched by the finger center M1. The cursor 221 is a highlighted symbol (such as an arrow or cross symbol);

c. determine whether the finger is absent for a set time period (step 633): if the finger M is moved away from the touch panel 11 for a set time period (set by the system), execute step 634; otherwise execute step 635;

d. remove the cursor (step 634): make the cursor 221 disappeared from the screen 20, and execute step 300; and

e. generate icon alteration for the option (step 635): the zones 114, 115, 116, 117 and 118 where the finger center M1 is located are corresponding to options 244, 245, 246, 247 and 248 displayed on the screen 20, then generate icon alterations on the options 244, 245, 246, 247 and 248 (such as inverse color or surrounded by a frame 2451), and execute step 700.

By means of the procedures set forth above, when user's finger moves away from the touch panel 11 for the set time period, the cursor 221 disappears, and the picture of the screen 20 returns to the opening option page to facilitate user operation for the next cycle.

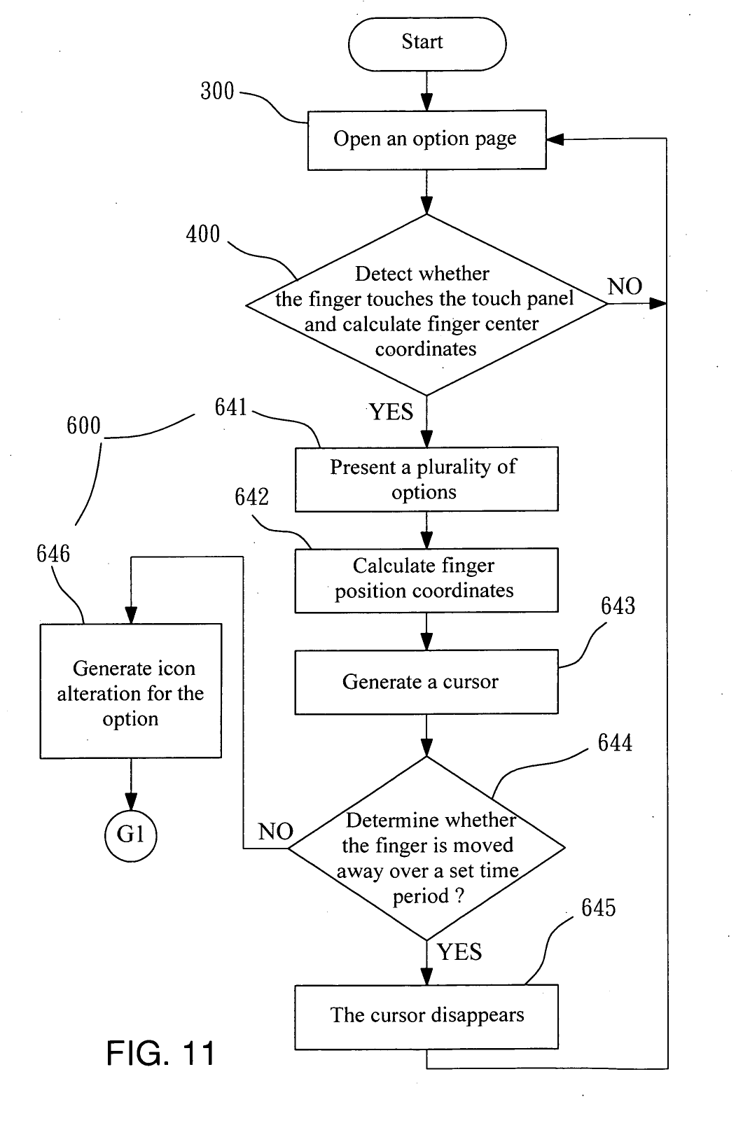

Refer to FIG. 11 (also FIG. 8) for a fourth embodiment of step 600 for generating icon alteration of a corresponding option. It includes procedures as follow:

a. present a plurality of options (step 641): display a plurality of options 244, 245, 246, 247 and 248 on the screen 20, and the touch panel 11 is divided into more than one zone 114, 115, 116, 117 and 118 corresponding to the options 224, 245, 246, 247 and 248;

b. calculate the coordinate of finger position (step 642): get the coordinate position of the finger center M1 on the touch panel 11;

c. generate a cursor (step 643): display a cursor 221 at the corresponding position A on the screen 20 according the touch coordinate position of the mapping finger center M1 to allow users to understand the position touched by the finger center M1. The cursor 221 is a highlighted symbol (such as an arrow or cross symbol);

d. determine whether the finger is absent for a set time period (step 644): if the finger M is moved away from the touch panel 11 for a set time period (set by the system), execute step 645; otherwise execute step 646;

e. remove the cursor (step 645): make the cursor 221 disappeared from the screen 20, and execute step 300; and

f. generate icon alteration for the option (step 646): the zones 114, 115, 116, 117 and 118 where the finger center M1 is located are corresponding to the options 244, 245, 246, 247 and 248 displayed on the screen 20; then generate icon alterations on the options 244, 245, 246, 247 and 248 (such as inverse color or surrounded by a frame 2451), and execute step 700.

By means of the procedures set forth above, when user's finger moves away from the touch panel 11 for the set time period, the cursor 221 disappears, and the picture of the screen 20 returns to the opening option page to facilitate user operation for the next cycle.

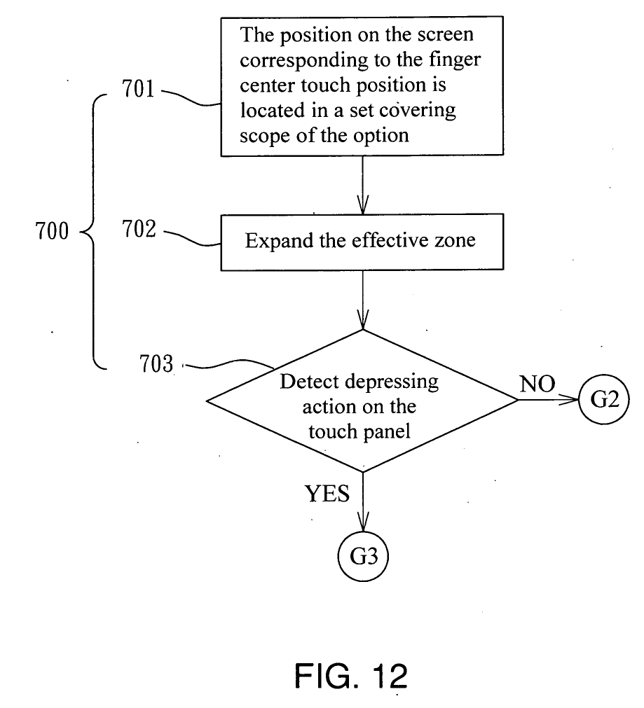

In order to make selection of the option more accurate, the step 700 of execute a measure to prevent depressing deviation further includes the following procedures (referring to FIGS. 4, 12 and 13):

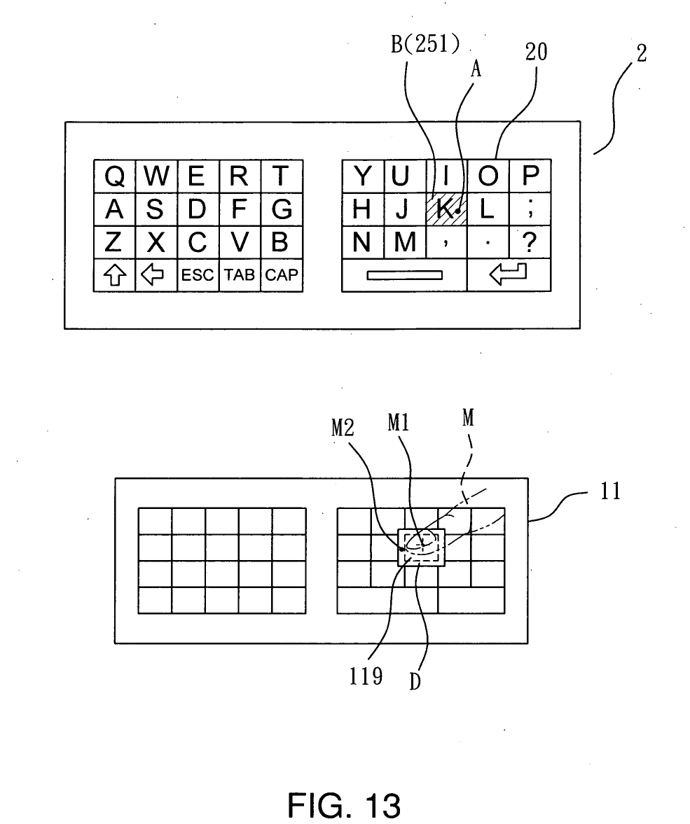

a. map finger center touch position to a corresponding position on the screen in a set covering scope of options (step 701): the touch panel 11 has a plurality of zones 119 corresponding to a plurality of options 251 on the screen 20. When the finger center M1 touches the zones 119 and the corresponding position A on the screen 20 is located in a set covering scope B of the options 251 (shown by a shade portion in FIG. 13), execute step 702;

b. expand the effective zones (step 7 02): When the position of the finger center M1 is corresponding to the position A on the screen 20 that is located in the set covering scope B of the option 251, the zone 119 of the touch panel 11 corresponding to the option 251 (such as character K) has its effective zone expanded to a bordering zone D so that when the finger M depresses the zone 119 the depressing spot M2 has a greater depressible area; and

c. detect depressing action of the touch panel (step 703): detect whether the depressing force of the finger M is greater than a set value; if the outcome is positive, execute step 800; otherwise execute step 300.

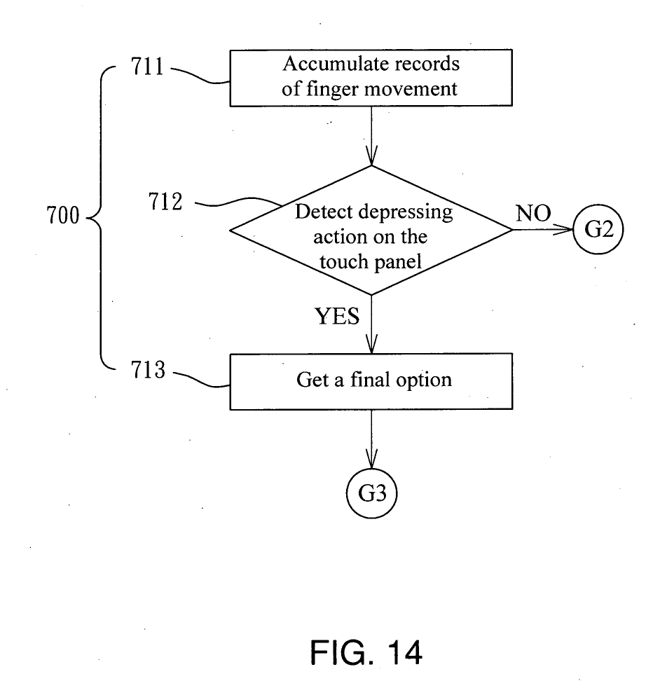

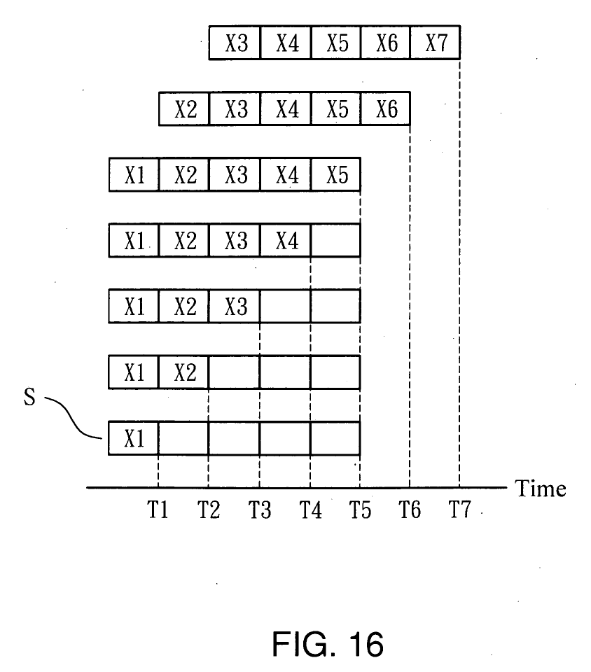

Refer to FIGS. 4, 14, 15 and 16 for a second embodiment of step 700 of execute a measure to prevent depressing deviation. Aside from expanding the effective zone of the option, the options of a selected preceding time period can be claimed retrospectively based on timeline. Even if a deviation takes place during depressing of the depressing spot of the finger M the option being selected and depressed still is deemed valid. The procedures are as follow:

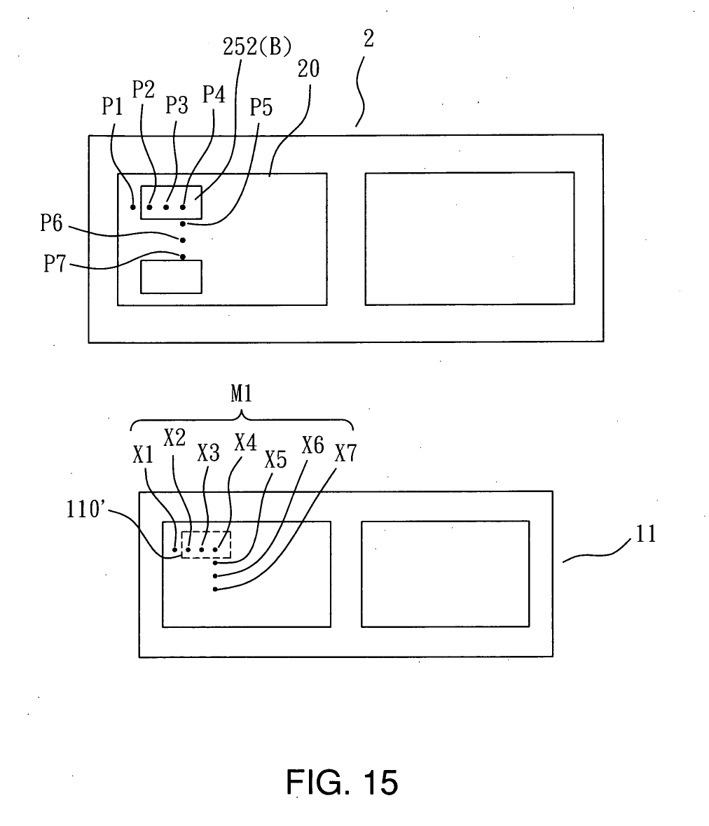

a. accumulate records of finger movement (step 711): enter continuously coordinate values X1, X2, X3, X4, X5, X6 and X7 of the finger center M1 in a memory space S (five segments are set in FIG. 15 as an example), based on first in first out principle, according to the position of the finger center M1 on the touch panel 11. The coordinate value of the initial position of the finger center M1 is erased;

b. detect depressing action of the touch panel (step 712): when the depressing force of the finger center M1 is greater than a set value, the depressing action is deemed valid, then execute step 713; otherwise execute step 300; and

c. get a final option (step 713): retrieve sequentially the position coordinate values X1, X2, . . . , X7 from the memory space S of the finger center M1 to map an option 252 on the screen 20. In the event that the coordinate values X1, . . . , X7 are located within a set covering scope B of the option 252, select the option 252, and execute step 800.

By means of the procedures previously discussed, when a user's finger touches the touch panel 11, the position coordinate values X1, . . . , X7 in the memory space S of the finger center M1 are constantly updated. For instance, if the user's finger moves sequentially within the time period of T1-T7 from the coordinate value X1 to X7 (corresponding to segments P1-P7 on the screen 20), after the step of detect depressing action of the touch panel (step 712) the step of get a final option (step 713) retrieves sequentially the coordinate values X1, . . . , X7 from the memory space S of the finger center M1 position corresponding to the option 252 on the screen 20. The closest one is at time T4, hence the option 252 corresponding to the coordinate value at X4 on the touch panel 11 where the finger center M1 is located is entered. Such an approach can prevent errors caused by confirmation delay of the option 252 (such as related to thinking, looking or the like) when the touch panel 11 is depressed. For instance, if the finger center M1 stays at a zone 110′ of the touch panel 11 that represents the option 252 for a selected duration, movement of the finger M occurs due to depressing of the finger center M1 (usually moving downwards), once the action of depressing the touch panel is detected (step 712), an unintended movement (namely the finger position has been moved from X4 to X7) has occurred, and the movement is outside the zone 110′ representing the option 252 (such as X7), then an erroneous action could take place. Through the procedures previously discussed such a problem can be avoided.

As a conclusion, the method according to the invention provides remote operation in a more user-friendly fashion, and can shorten the time of trials and errors for users. It offers a significant improvement over the conventional techniques.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

I claim:

1. An icon/text interface control method, comprising at least the steps of:
opening an option page;
detecting contact of a user's finger on a touch panel and calculating coordinates of the finger center;
mapping the position of the finger center to a screen;
generating icon alteration of a corresponding option;
executing a measure to prevent depressing deviation; and
executing the selected option.

2. The icon/text interface control method of claim 1, wherein the step of opening an option page displays a picture of a plurality of options on the screen of a display device.

3. The icon/text interface control method of claim 1, wherein the step of opening an option page maps coordinates of the screen and the touch panel by absolute coordinates in an one-to-one fashion.

4. The icon/text interface control method of claim 1, wherein the step of opening an option page has segments on the screen for the options, the touch panel being divided into more than one zone corresponding to the segments.

5. The icon/text interface control method of claim 1, wherein the step of detecting a user's finger on a touch panel and calculating coordinates of the finger center detects a finger touch signal by the touch panel to calculate the coordinates of the finger center.

6. The icon/text interface control method of claim 1, wherein the step of mapping the position of the finger center to a screen maps a coordinate of the touch panel to another corresponding coordinate on the screen so that the position of the finger center corresponds to a corresponding position on the screen.

7. The icon/text interface control method of claim 1, wherein the step of mapping the position of the finger center to a screen generates a cursor at a corresponding position on the screen.

8. The icon/text interface control method of claim 1, wherein the step of generating icon alteration of a corresponding option generates an icon alteration of the corresponding option when the finger center is located in a set covering scope of the corresponding option on the screen.

9. The icon/text interface control method of claim 1, wherein the step of executing a measure to prevent depressing deviation expands temporarily a depressing effective zone of the touch panel to compensate a depressing deviation when the position on the screen corresponding to the finger center is located in a set covering scope of the corresponding option.

10. The icon/text interface control method of claim 9, wherein the depressing effective zone is expanded to a bordering zone thereof.

11. The icon/text interface control method of claim 1, wherein the step of executing a measure to prevent depressing deviation includes options of a selected preceding time period claimed retrospectively based on timeline even if the finger center has deviated from the selected options during depressing.

12. The icon/text interface control method of claim 1, wherein the step of executing the selected option outputs function of the selected option.

13. The icon/text interface control method of claim 1, wherein the step of opening an option page is executed after the step of detecting a user's finger on a touch panel and calculating coordinates of the finger center.

14. The icon/text interface control method of claim 13, wherein the step of opening an option page is revoked after the step of detecting contact of a user's finger on a touch panel and calculating coordinates of the finger center does not exist and absence of the finger from the touch panel for a set time period is detected, and a preceding page is resumed.
